(19) United States
(12) Patent Application Publication
(10) Pub. No.: US 2017/0108644 A1
(43) Pub. Date: Apr. 20, 2017

(54) RIGHT-ANGLE WAVEGUIDE BASED ON SQUARE-CYLINDER-TYPE SQUARE-LATTICE PHOTONIC CRYSTAL AND DUAL COMPENSATION SCATTERING CYLINDERS WITH HIGH REFRACTIVE INDEX

(71) Applicant: ZHENGBIAO OUYANG, SHENZHEN (CN)

(72) Inventors: Zhengbiao Ouyang, Shenzhen (CN); Hao Huang, Shenzhen (CN)

(73) Assignee: ZHENGBIAO OUYANG

(21) Appl. No.: 15/395,205

(22) Filed: Dec. 30, 2016

Related U.S. Application Data
(63) Continuation of application No. PCT/CN2015/090871, filed on Sep. 28, 2015.

(30) Foreign Application Priority Data
Sep. 29, 2014 (CN) 201410515304.1

(51) Int. Cl. G02B 6/122; G02B 6/125

(52) U.S. Cl. CPC G02B 6/1225; G02B 6/125

(57) ABSTRACT

A right angle waveguide having a square rod-type square lattice photonic crystal and dual compensation scattering rods having a high refractive index. The right angle waveguide is a photonic crystal formed from first dielectric rods having a high refractive index arranged in a background dielectric having a low refractive index according to a square lattice. In the photonic crystal, one row and one column of the first dielectric rods having the high refractive index are removed to form the right angle waveguide. Second and third dielectric rods having a high refractive index are respectively arranged at the two corners, of the right angle waveguide, the second and third dielectric rods being the compensation scattering rods. The first dielectric rods are square rods having the high refractive index. The right angle waveguide has extremely low reflectance and a very high transmission rate, and facilitates large-scale optical path integration.

### CROSS-REFERENCE TO RELATED APPLICATIONS

This application is a continuation of International Patent Application No. PCT/CN2015/090871 with a filing date of Sep. 28, 2015, designating the United States, now pending, and further claims priority to Chinese Patent Application No, 201410515304.1 with a filing date of Sep. 29, 2014. The content of the aforementioned applications, including any intervening amendments thereto, are incorporated herein by reference.

### TECHNICAL FIELD

The present invention relates to a photonic crystal bending waveguide, and in particular relates to a right-angle waveguide based>on a square-cylinder-type square-lattice photonic crystal and dual compensation scattering cylinders with a high refractive index.

### BACKGROUND OF THE PRESENT INVENTION

In 1987, E. Yablonovitch from a Bell laboratory of the United States, who was discussing about how to inhibit spontaneous radiation, and S. John from Princeton University, who was discussing about a photon localization, respectively and independently proposed the concept of photonic crystal (PhC) The PhC is a material structure formed in a way that dielectric materials are periodically arranged in space and an artificial crystal which is composed of two or more than two materials with different dielectric constants. The PhC has stronger and flexible control capability for propagation of light and high transmission efficiency for linear transmission and, sharp right-angle transmission. If a line defect is introduced into the structure of the PhC, a light guiding channel is created, called as a photonic crystal waveguide (PCW), Even if the waveguide has a 90-degree corner, the waveguide only has a very little loss. Completely different from conventional waveguides with basic total internal reflection, the PCW mainly utilizes a waveguide effect of a defect state; a new photon, state is formed inside a photonic band gap (PBG) due to the introduction of the defect, while the photon state density deviating from the defect state is zero Therefore, the PCW realizes light transmission in a defect mode, without causing mode leakage. The PCW is a basic device for forming optical integrated circuits, the right-angle PCW can improve the integration level of optical circuits, and the research related to right-angle PCWs has important significance for the development of the optical integrated circuits.

### SUMMARY OF PRESENT INVENTION

The present invention aims at overcoming the defects in the prior art to provide a right-angle waveguide based on a square-cylinder-type square-lattice PhC and dual compensation scattering cylinders with high refractive index, and the right-angle waveguide has extremely low reflectance and very high transmission rate.

The aim prevent invention is realized through a technical solution below.

The right-angle waveguide based on said square-cylinder-type square-lattice photonic crystal and the dual compensation scattering cylinders with the high refractive index according, to the present invention is built in a PhC formed from first dielectric cylinders with high refractive index arranged in a background dielectric with low refractive index according to a square lattice. In the PhC, one row and one column of the first dielectric cylinders with high refractive index are removed to form the right-angle waveguide; a second and a third dielectric cylinders with high refractive index are respectively arranged at two corners of said right-angle waveguide; the second and the third dielectric cylinders with high refractive index are said compensation scattering cylinders; and said first dielectric cylinders are square cylinders with high refractive index.

Said second and said third dielectric cylinders are isosceles right triangle cylinders, arch shaped cylinders, square cylinders, triangular cylinders, polygonal cylinders of more than three sides, or cylinders, of which the outlines of the cross sections are smooth closed curves.

Said second and the third dielectric cylinders are the isosceles right triangle cylinders.

The material of said first dielectric cylinders with high refractive index is Si, gallium arsenide, titanium dioxide, or a different dielectric with refractive index of more than 2.

The material of said first dielectric cylinders with high refractive index is Si, and the refractive index of Si is 3.4.

The material of said background dielectric with low refractive index is air, vacuum, magnesium fluoride, silicon dioxide, or a different dielectric with a refractive index of less than 1.6.

Said background dielectric with low refractive index is air.

Said right-angle waveguide is a waveguide operating in a transverse electric (TE) mode.

The area of the structure of said right-angle waveguide is more than or equal to 7a*7a, and a is the lattice constant of the PhC.

A PhC waveguide device of the present invention can be widely applied in various photonic or optical integrated devices. Compared with the prior art, the PhC said waveguide device according to the present invention has the positive effects below:

1. Said right-angle waveguide based on said square-cylinder-type square-lattice photonic crystal and said dual compensation scattering cylinders with high refractive index according to the present invention has very low reflectance and very high transmission rate, thereby providing a greater space for application of said right-angle PCW;

2. The structure of the present invention is based on multiple scattering theory, phase and amplitude compensations for reducing the reflectance and improving the transmission rate of optical waves transmitted in said structure are realized by said dual dielectric compensation scattering cylinders with high refractive index, so as to reduce the reflectance and improve the transmission rate, and therefore, said structure can realize low reflectance and high transmission rate;

3. Said right-angle waveguide based on said square-cylinder-type square lattice photonic crystal and said dual compensation scattering cylinders with high refractive index according to the present invention can be used in design for large-scale optical integrated circuits; the optical circuits are concise and are convenient to design, and said right-angle waveguide facilitates large-scale integration of optical circuits;

4. Said right-angle waveguide based on said square cylinder-type square lattice photonic crystal and said dual compensation scattering cylinders with high refractive index according to the present invention can realize connection and coupling of different elements in optical circuits and among different optical circuits, thereby being favorable to lowering the cost.

### DESCRIPTION OF THE DRAWINGS

FIG. 1 is the schematic diagram of the core region of the structure of the right-angle waveguide based on a square-cylinder-type square-lattice photonic crystal and dual compensation scattering cylinders with high refractive index according to the present invention;

FIG. 2 is the normalized frequency-transmission characteristic diagram of the right-angle waveguide based on the square-cylinder-type square-lattice photonic crystal and the dual compensation scattering cylinders with high refractive index according to the present invention.

### DETAILED DESCRIPTION OF PREFERRED EMBODIMENTS

Implementation manners of the present invention are further illustrated in combination with the drawings.

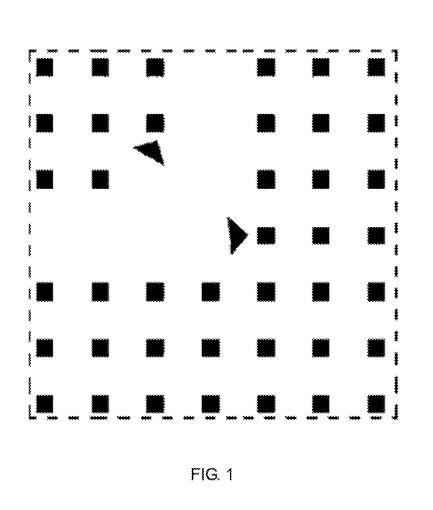

As shown in FIG. 1, a right-angle wave aide based on a square-cylinder-type square-lattice photonic crystal and dual compensation scattering cylinders with high refractive index according to the present invention: the PhC is formed from said first dielectric cylinders with high refractive index arranged in a background dielectric with low refractive index according to square lattice. In said PhC, one row and one column of said first dielectric cylinders with high refractive index are removed to form the right-angle waveguide; a second and a third dielectric cylinders with high refractive index are respectively arranged at two corners of the right-angle waveguide, said second and said third dielectric cylinders are compensation scattering dielectric cylinders, and the compensation reflected waves generated by the second dielectric cylinder are offset by the intrinsic reflected waves in the waveguide without said compensation scattering dielectric; said compensation scattering dielectric cylinders are further adopted as: an isosceles right triangle cylinder, an arch shaped cylinder, a square cylinder, a triangular cylinder and a polygonal cylinder of more than three sides; or, further cylinders, of which the outlines of the cross sections are smooth closed curves; said second and third dielectric cylinders (compensation scattering dielectric cylinders) are respectively the isosceles right triangle cylinders; and the material of said first dielectric cylinders with high refractive index is respectively adopted as Si, gallium arsenide, titanium dioxide, or a different dielectric with refractive index of more than 2; and the material of the background dielectric with low refractive index is adopted as air, vacuum, magnesium fluoride, silicon dioxide, or a different dielectric with refractive index of less than 1.6.

Six embodiments are shown below according to the above result:

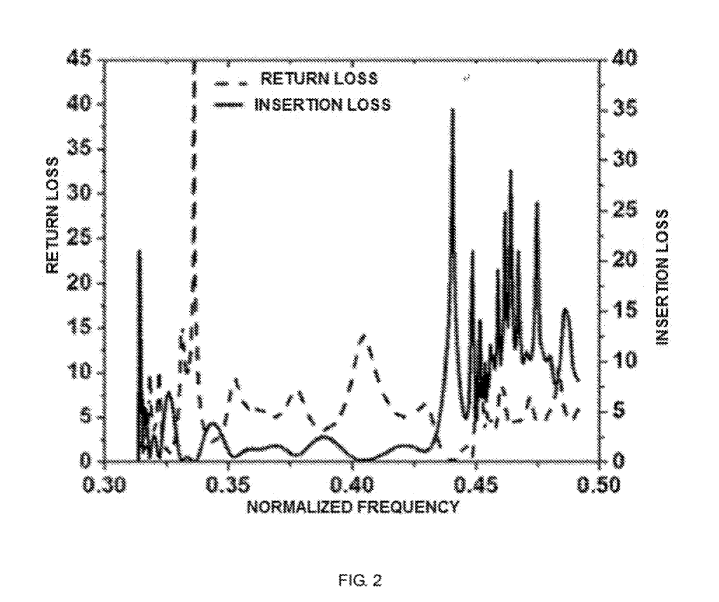

Embodiment 1: the lattice constant of said square-lattice PhC is a; said first dielectric cylinders with high refractive index are adopted as square cylinders, the side length of each square cylinder is 0.31a; the polarization of optical waves transmitted in the waveguide is TE form; said second dielectric cylinder is adopted as an isosceles right triangle cylinder, and further, the length of the right-angle side of the isosceles right triangle compensation scattering dielectric cylinder with high refractive index at the upper left corner is 0.46255a; the displacements of said compensation scattering dielectric cylinder in the X direction and in the Z direction measured from the original benchmark point are respectively 2.02188a and 2.28110a, and the rotation angle is 1631 degrees; the reference axis of the rotation angle is the horizontal right-hand, axis, and the rotation direction is the clockwise direction; the X axis is in a horizontal right-hand direction, and the Z axis is in a vertical upward direction; the third dielectric cylinder is adopted as an isosceles right triangle cylinder, the right-angle side length of the isosceles right triangle dielectric compensation scattering cylinder with high refractive index at the lower right corner is 0.48022a; the displacements of said compensation scattering cylinder in the X direction and in the Z direction measured from the original benchmark point are respectively 0.36482a and 037634a, and the rotation angle is 220 degrees; the position of an optical source in the X direction and in the 2 direction measured from the coordinate origin is −6.00 a, 0); and the initial phase of incident light (the optical source) is 67.8 degrees. The dielectric with high refractive index is Si, and the refractive index of Si is 3.4; and, the background dielectric with low refractive index is air. The structure size of the right-angle waveguide formed in the PhC is 15a*15a, a return loss spectrum and an insertion loss spectrum of the right-angle waveguide formed in the PhC are then obtained and shown in FIG. 2, the horizontal axis of the figure is the operating frequency of the structure, the longitudinal axis part of the figure indicates transmission, the dash line in the figure indicates the return loss of the structure (defined as: LR=−10 log (PR/PI), while the solid line in the figure indicates the insertion loss (defined as: LI=−10 log (PT/PI), wherein PI is the incident power of the structure, PR is the reflection power of the structure, and PT is the transmission power of the structure. At the normalized frequency of 0.336 (ωa/2πc), the maximum return loss and the minimum insertion loss of the right-angle waveguide formed in the Ph C are 44.29 dB and 0.0022 dB.

Embodiment 2: the lattice constant a of said square-lattice Ph C is 0.5208 μm, so that the optimal normalized wavelength is 1.31 μm; said first dielectric cylinders with high refractive index are adopted as square cylinders, and the side length of each square cylinder is 0.161448 μm; the polarization of optical waves transmitted in the waveguide is TE form; said second dielectric cylinder is adopted as an isosceles right triangle cylinder, and further, the length of the right-angle side of the isosceles right triangle compensation scattering dielectric cylinder with high refractive index at the upper left corner is 0.2409 μm; the displacements of said compensation scattering dielectric cylinder in the X direction and in the Z direction measured from the original benchmark point are respectively 1.0 μm and 1.188 μm, and the rotation angle is 299 degrees; the reference axis of the rotation angle is the horizontal right-hand axis, and the rotation direction is the clockwise direction; the X axis is in the horizontal right-hand direction, and the Z axis is in a vertical upward direction; the, third dielectric cylinder is adopted as an isosceles right triangle cylinder, i.e., the length of the right-angle side of the isosceles right triangle dielectric compensation scattering cylinder with high refractive index at the lower right corner is 0.2501 μm; the displacements of said compensation scattering cylinder in the X direction and in the Z direction measured from the original benchmark point are respectively 0.1 μm and 0.196 μm; the rotation angle is 131.5 degrees; the position of an optical source measured from the coordinate origin in the X direction and in the Z direction is (−3.1248, 0) (μm); and the initial phase of incident light (the optical source) is 67.8 degrees. The dielectric with high refractive index is silicon (Si), and the refractive index of Si is 3.4; and the background dielectric with low refractive index is air The structure size of the right-angle waveguide formed in the PhC is 15a*15a, and the return loss and the insertion loss of the right-angle waveguide formed in the PhC are respectively 7.254977 dB and 0.905307 dB.

Embodiment 3: the lattice constant a of said square-lattice PhC is 5208 μm, so that the optimal normalized wavelength is 1.55 μm; said first dielectric cylinders with high refractive index are adopted as square cylinders, and the side length of square cylinder is 0.161448 μm; the polarization of optical waves transmitted in said waveguide is TE form; said second dielectric cylinder is adopted as an isosceles right triangle cylinder, and further, the length of the right-angle side of the isosceles right triangle compensation scattering dielectric cylinder with high refractive index at the upper left corner is 0.2409 μm; the, displacements of said compensation scattering dielectric cylinder in the X direction and in the Z direction measured from the original benchmark point are respectively 1,053 μm and 1.188 μm, and the rotation angle is 299 degrees; the reference axis of the rotation angle is the horizontal right-hand axis, and the rotation direction is the clockwise direction; the X axis is in the horizontal right-hand direction, and the Z axis is in a vertical upward direction; said third dielectric cylinder is adopted as an isosceles right triangle cylinder, and the length of the right-angle side of the isosceles right triangle dielectric compensation scattering cylinder with high refractive index at the lower right corner is 0.2501 μm; the displacements of said compensation scattering dielectric cylinder in the X direction and in the Z direction measured from the original benchmark point are respectively 0.19 μm and 0.196 μm; the rotation angle is 131.5 degrees; the position of an optical source measured from the coordinate origin in the X direction and in the Z direction is (−3.1248, 0) (μm); and the initial phase of incident light (the optical source) is 67.8 degrees, The dielectric with high refractive index is silicon (Si), and the refractive index of Si is 3.4; and the background dielectric with low refractive index is air. The structure size of the right-angle waveguide formed in the PhC is 15a*15a. At the normalized frequency of 0.336(ωa/2πc), the maximum return loss and the minimum insertion loss of the right-angle waveguide formed in the PhC are respectively 44.29 dB and 0.0022 dB.

Embodiment 4: the lattice constant a of a square-lattice PhC is 0.336 μm, so that the optimal normalized wavelength is 1.00 μm; said first dielectric cylinders with high refractive index are adopted as square cylinders, and the side length of, each square, cylinder is 0.10416 μm; the polarization of optical waves transmitted in the waveguide is TE form; said second dielectric cylinder is adopted as an isosceles right triangle cylinder, and further, the length of the right-angle side of the isosceles right triangle compensation scattering dielectric cylinder with high refractive index at the upper left corner is 0.155417 μm; the displacements of said compensation scattering dielectric cylinder in the X direction and in the Z direction measured from the original benchmark point are respectively 0.679352 μm and 0.76645 μm, and the rotation angle is 163.7 degrees; the reference axis of the rotation angle is the horizontal right-hand axis, and the rotation direction is the clockwise direction; the X axis is in the horizontal right-hand direction, and the Z axis is in a vertical upward, direction; the third dielectric cylinder is adopted as an isosceles right triangle cylinder, and the length of the right-angle side of the isosceles right triangle dielectric compensation scattering cylinder with high refractive index at the lower right corner is 0.161354a; the displacements of said compensation scattering dielectric cylinder in the X direction and in the Z direction measured from the original benchmark point are respectively 0.12258 μm and 0.12645 μm; the rotation angle is 220 degrees; the position of an optical source measured from the coordinate origin in the X direction and in the Z direction is (−2.016, 0) (μm); and the initial phase of incident light (the optical source) is 67.8 degrees, The dielectric with high refractive index is silicon (Si), and the refractive index of Si is 3.4; and the background dielectric with low refractive index is air. The structure size of the right-angle waveguide formed in the PhC is 15a*15a. A return loss spectrum and an insertion loss spectrum of the right-angle waveguide formed in the PhC are then obtained and shown in FIG. 2. At the normalized frequency of 0.336(ωa/2πc), the maximum return loss and the minimum insertion loss of the right-angle waveguide formed in the PhC are 44.29 dB and 0.0022 dB.

Embodiment 5: the lattice constant a of said square-lattice PhC is 0.49728 μm, so that the optimal, normalized wavelength is 1.48 μm; said first dielectric cylinders with high refractive index are adopted as square cylinders, and the side length of each square cylinder is 0.154157 μm; the polarization of optical waves transmitted in the waveguide is TE form; said second dielectric cylinder is adopted as an isosceles right triangle cylinder, and the length of the right-angle side of the isosceles, right triangle compensation scattering dielectric cylinder with high refractive index at the upper left corner is 0.230017 μm; the displacements of said compensation scattering dielectric cylinder in the X direction and in the Z direction measured from the original benchmark point are respectively 1.00544 μm and 1.134345 μm, and the rotation angle is 163.7 degrees; the reference axis of the rotation angle is the horizontal right-hand axis, and the rotation direction is the clockwise direction; the X axis is in the horizontal right-hand direction, and the Z axis is in a vertical upward direction; said third dielectric cylinder is adopted as an isosceles right triangle cylinder, and the length of the right-angle side of the isosceles right triangle dielectric compensation scattering cylinder with high refractive index at the lower right corner is 0.238804 μm; the displacements of said compensation scattering cylinder in the X direction and in the Z direction measured from the original benchmark point are respectively 0.181418 μm and 0.1871445 μm; the rotation angle is 220 degrees; the position of an optical source measured from the coordinate origin in the X direction and in the Z direction is (−2.98368, 0) (μm); and the initial phase of incident light (the optical source) is 67.8 degrees. The dielectric with high refractive index is silicon (Si), and the refractive index of Si is 3.4; and the background dielectric with low refractive index is air. The structure size of the right-angle waveguide formed in the PhC is 15a*15a. A return loss spectrum and an insertion loss spectrum of the right-angle waveguide formed in the PhC are then obtained and shown in FIG. 2. At the normalized frequency of 0.336(ωa/2πc), the maximum return loss and the minimum insertion loss of the right-angle waveguide formed in the PhC are 44.29 dB and 0.0022 dB.

Embodiment 6: the lattice constant a of said square-lattice PhC is 168 μm, so that the optimal normalized wavelength is 500 μm; said first dielectric cylinders with high refractive index are adopted as square cylinders, and the side length of each square cylinder is 52.08 μm; the polarization of optical waves transmitted in the waveguide is TE form; said second dielectric cylinder is adopted as an isosceles right triangle cylinder, and further, the length of the right-angle side of the isosceles right triangle compensation scattering dielectric cylinder with high refractive index at the upper left corner is 77.7084 μm; the displacements of said compensation scattering dielectric cylinder in the X direction and in the Z direction measured from the original benchmark point are respectively 339.6758 μm and 383.2248 μm, and the rotation angle is 163.7 degrees; the reference axis of the rotation angle is the horizontal right-hand axis, and the rotation direction is the clockwise direction; the X axis is in the horizontal right-hand direction, and the Z axis is in a vertical upward direction; said third dielectric cylinder is adopted as an isosceles right triangle cylinder, and the length of the right-angle side of the isosceles right triangle dielectric compensation scattering cylinder with high refractive index at the lower right corner is 80.67696 μm; the displacements of said compensation scattering cylinder in the X direction arid in the Z direction measured from the original benchmark point are respectively 61.28976 μm and 63.22512 μm; the rotation angle is 220 degrees; the position of an optical source measured from the coordinate origin in the X direction and in the Z direction is (−1008, 0) (μm); and the initial phase of incident light (the optical source) is 67.8 degrees. The dielectric with high refractive index is silicon (Si), and the refractive index of Si is 3.4; and the background dielectric with low refractive index is air. The structure size of the right-angle waveguide formed in the PhC is 15a*15a. A return loss spectrum and an insertion loss spectrum of the right-angle waveguide formed in the PhC are then obtained and shown in FIG. 2. At the normalized frequency of 0.336(ωa/2πc), the maximum return loss and the minimum insertion loss of the right-angle waveguide formed in the PhC are 44.29 dB and 0.002 dB.

The above detailed description is only for clearly understanding the present invention and should not be taken as an unnecessary limit to the present invention. Therefore, any modification made to the present invention is apparent for those skilled in the art.

We claim:

1. A right-angle waveguide based on a square-cylinder-type square-lattice photonic crystal and dual compensation scattering cylinders with high refractive index, characterized in that: said right-angle waveguide is built in a PhC formed from first dielectric cylinders with high refractive index arranged in a background dielectric with low refractive index according to square lattice. In said PhC, one row and one column of said first dielectric cylinders with high refractive index are removed to form said right-angle waveguide; a second and a third dielectric cylinders with high refractive index are arranged at two corners of the right-angle waveguide; said second and said third dielectric cylinders are the compensation scattering cylinders and said first dielectric cylinders are, square cylinders with high refractive index.

2. The right-angle waveguide based on said square-cylinder-type square-lattice photonic crystal and said dual compensation scattering cylinders with high refractive index according to claim 1, characterized in that: said second and said third dielectric cylinders are isosceles right triangle cylinders, arch shaped cylinders, square cylinders, triangular cylinders, polygonal cylinders of more than three side, or cylinders, of which the outlines of the cross sections are smooth closed curves.

3. The right-angle waveguide based on said square-cylinder-type square-lattice photonic crystal and said dual compensation scattering cylinders with high refractive index according to claim 2, characterized in that: said second and said third dielectric cylinders are the isosceles right triangle cylinders.

4. The right-angle waveguide based on said square-cylinder-type square-lattice, photonic crystal and said dual compensation scattering cylinders with high refractive index according to claim 1, characterized in that the material of said first dielectric cylinders with high refractive index is Si, gallium arsenide, titanium dioxide, or a different dielectric with refractive index of more than 2.

5. The right-angle waveguide based on said square-cylinder-type square-lattice photonic crystal and said dual compensation scattering cylinders with high refractive index according to claim 4, characterized in that: the material of said first dielectric cylinders with high refractive index is silica, and the refractive index of Si is 3.4.

6. The right-angle waveguide based on said square-cylinder-type square-lattice photonic crystal and said dual compensation scattering cylinders with high refractive index according to claim 1, characterized in that: the material of said background dielectric with low refractive index is air, vacuum, magnesium fluoride, silicon dioxide, or a different dielectric with refractive index of less than 1.6.

7. The right-angle waveguide based on said square-cylinder-type square-lattice photonic crystal and said dual compensation scattering cylinders with high refractive index according to claim 6, characterized in that: said background dielectric with low refractive index is air.

8. The right-angle waveguide based on said square-cylinder-type square-lattice photonic crystal and said dual compensation scattering cylinders with high refractive index according to claim 1, characterized in that: the right-angle waveguide is a waveguide operating in a TE mode.

9. The right-angle waveguide based on said square-cylinder-type square-lattice photonic crystal and said dual compensation scattering cylinders with high refractive index according to claim 1, characterized in that: the area of the structure of said right-angle waveguide is more than or equal to 7a*7a, and a is the lattice constant of said PhC.
